(19) United States
(12) Patent Application Publication
(10) Pub. No.: US 2009/0230642 A1
(43) Pub. Date: Sep. 17, 2009

(54) Hitch mounted shopping cart carrier device and methods of use therein

(76) Inventor: James P. Thomas, Holt, FL (US)

Correspondence Address: JAMES PAUL THOMAS, 1195 E. JEFFERSON ST., PULASKI, TN, 38478, US

(21) Appl. No.: 12/049,389

(22) Filed: Mar. 17, 2008

(51) Int. Cl. B62B 3/02; G06Q 30/00

(52) U.S. Cl. 280/33.992; 705/14

(57) ABSTRACT

A hitch mounted shopping cart carrier device for receipt of a conventional shopping cart. The device includes a hitch bar having frontal and posterior ends, said frontal end being adapted for mounting in a hitch receiver of a vehicle, said posterior end is rigidly affixed to the underside of a platform assembly. Said platform assembly having an essentially horizontal floor with left and right ends, a narrow front face extending vertically upwardly from the right end of said horizontal floor, a wider opening at left end of said horizontal floor and tapering sides therebetween. A loading ramp is rotatably attached to said left end of said horizontal floor. Said loading ramp further comprises a latch means for securing said loading ramp in a raised position. An advertising method wherein the viewable surfaces of said platform assembly have advertisements placed thereon. Said advertisements further comprises at least one detachable coupon thereon.

### BACKGROUND OF THE INVENTION

1. Field of the Invention

The present invention relates to cargo carriers for transporting goods or personal belongings, and more particularly to a hitch mounted shopping cart carrier device with the above mentioned methods which can be used for transporting a wheeled conventional type shopping cart loaded with groceries without unloading the contents of the shopping cart into an automotive vehicle. The hitch mounted shopping cart carrier device with the above mentioned methods also provides an advertising medium.

2. Description of the Prior Air

A variety of designs or systems for cargo carriers attachable to the exterior of motor vehicles have been proposed and many have become commonplace and are in wide use. Most commonly, cargo carriers are connected or coupled to the rear of the vehicle, and typically attached to a receiver type trailer hitch. These tailgate type carriers, disposed outside the vehicle, are versatile, and provide suitable means for transporting extra or bulky loads. Thus, it has long been recognized that a carrier is advantageous in that it provides extra storage capacity for transporting cargo, or increases the carrying capacity of a vehicle such as with today's smaller or more compact vehicles having limited storage capacity, or provides carrying capacity for relatively large, heavy, or bulky items. Because of this carrying capacity, cargo carriers are therefore utilized for supporting and transporting a wide variety of items or materials, such as trunks, luggage, coolers, recreational and sports equipment (e.g., bicycles, skis, and camping equipment), electric scooters and wheelchairs etc. It is well known that conventional type shopping carts, of the kind typically found in supermarkets, department stores or other such stores are characterized by their use wherein the groceries, or other goods, are selected and placed in the shopping cart for transport to a check out station. The groceries are now unloaded onto a check-out counter. After scanning, or otherwise paying for the groceries, the groceries are again loaded back into the shopping cart. The shopping cart is moved to the vehicle wherein the groceries are once again unloaded and placed in the vehicle. After arriving at the final destination the groceries are removed from the vehicle and transported into the location of eventual use after sometimes making multiple trips back and forth to the vehicle. This requires the groceries to be handled multiple times which is inefficient and a burden especially to the elderly or those with infirmities, people with infants or small children, and especially for those who dwell in tall buildings. These people at times have to park their vehicles a distance from their building entrances. They have to carry their goods into the building, into the elevator, through the hallways, then finally into their dwelling units. These difficulties are further enhanced in inclement weather conditions. These conventional type shopping carts have never been sold or marketed to individual shoppers because there was not a way to transport conventional type shopping carts in the past by automotive vehicles. With the hitch mounted shopping cart carrier device, a shopper can use their own conventional type personal shopping cart for their grocery shopping and in doing so can enjoy a much easier grocery shopping trip, eliminating multiple transfers of groceries that occur today with an average grocery shopping trip.

The hitch mounted shopping cart carrier device of this invention in combination with ownership of a personal conventional type shopping cart provides a ready means for the individual homeowner to easily transport a conventional type personal shopping cart back and forth to the grocery store and to provide a means to make grocery shopping much easier. The shopper is always assured of a shopping cart for use during his shopping venture. Moreover, the hitch mounted shopping cart carrier device of the invention offers a further advantage in that during inclement weather, the shopper is not bothered with transferring bags of groceries from a shopping cart to his automobile but can merely load their personal shopping cart onto the hitch mounted shopping cart carrier device with the groceries contained therein and cover with a tarp for transport to their residence. This is done simply and with little effort. At the destination end, the personal shopping cart is removed from the hitch mounted shopping cart carrier device and rolled directly into the house for removal of the groceries in the kitchen or wherever else desired. The personal shopping cart can then be stored in a desirable area until it is needed once again for shopping. Ownership by individuals of personal conventional type shopping carts in accordance with this invention is, moreover, extremely advantageous to the storeowner now maintaining a rather large inventory of shopping carts. Costs of operations to the storeowner will be somewhat reduced as the inventory of carts needed by the store or market can be reduced as time goes on. As the personal shopping carts are owned by the individual shoppers, these carts will not become abandoned eyesores on city streets or in the parking lots of stores to become a nuisance to drivers. Useful types or systems of cargo carriers shown in the prior art mounted on the rear of a vehicle are connected to a vehicle receiver hitch and cantilevered therefrom in a substantially horizontal plane. Representative carriers of this type of system are disclosed in U.S. Pat. Nos. 5,439,151; 5,181,822; 5,460,304; 5,938,395 and 6,293,451. However, such vehicular attachable carriers known or disclosed in the art most typically comprise a mount and an integrally dependent rack, platform, or the like, for supporting and transporting a load.

An invention by Thomas Patent Application No. 20070126192, published on Jun. 7, 2007, for a “Shopping cart modified for vehicle transport” consists of a lift mechanism that raises the modified shopping cart off of the ground while attached to a receiver hitch of a motor vehicle.

An invention by Espejo Patent No. 7,080,844, Jul. 25, 2006, for a “Transportable shopping cart” consists of a transportable cart having a basket with a lift mechanism that raises the unit to the cargo floor height of the vehicle.

An invention by Gines Patent No. 6,070,899, Jun. 6, 2000, for a “Self-retracting cart for use in the cargo bay of a sport utility vehicle” consists of a self-retracting cart for use in the cargo bay of a sport utility vehicle.

An invention by Hubner, et al. Pat. No. 4,199,170, Apr. 22, 1980, for a “Carrier means” consists of a shopping cart supported for transport on the bumper of an automobile by brackets.

These current inventions do not disclose a hitch mounted shopping cart carrier device and methods of use therein that is adapted for receipt and transport of a conventional shopping cart. Therefore, a need exists for a new hitch mounted shopping cart carrier device and methods of use therein that allows the user to conveniently load and transport a conventional shopping cart with its contents intact without manually transferring their goods nor lifting the entire cart.

The hitch mounted shopping cart carrier device and methods of use therein can also be used for a variety of applications not limited to shopping. It can also be designed for use in commercial applications. Such commercial applications include, but are not limited to, food catering, delivery service, transport or construction materials, tools or equipment, and portable display cart.

### SUMMARY OF THE INVENTION

In view of the foregoing disadvantages inherent in the known types of cargo carriers of known designs and configurations now present in the prior art, the present invention provides a hitch mounted shopping cart carrier device and methods of use therein. As such, the general purpose of the present invention, which will be described subsequently in greater detail, is to provide a new hitch mounted shopping cart carrier device which has all the advantages of the prior art and none of the disadvantages. To attain this, the present invention essentially comprises a hitch mounted shopping cart carrier device that comprises a hitch bar having frontal and posterior ends, said frontal end of said hitch bar being adapted for mounting in a standard hitch receiver on a vehicle, said posterior end of said hitch bar is rigidly affixed to the underside of a platform assembly. Said platform assembly is configurated and dimensioned for the receipt of a wheeled conventional type shopping cart, said platform assembly being fabricated of metal wire, plastic resin, steel or aluminum mesh and having an essentially horizontal floor with left and right ends, a narrow front face extending upwardly from said right end of said horizontal floor, a wider opening at said left end of said horizontal floor and tapering sides there between. A winch assembly is rigidly affixed to the upper portion of said narrow front face. A loading ramp is rotatably attached to said left end of said horizontal floor of said platform assembly. Said loading ramp includes a latch means for securing said loading ramp in a raised upright position. All viewable surfaces of said platform assembly and loading ramp are adapted for receiving advertising indicia thereon.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention. It is therefore an object of the present invention to provide a new hitch mounted shopping cart carrier device and methods of use therein which has all of the advantages of the prior art cargo carriers of known designs and configurations and none of the disadvantages.

Accordingly, it is an object of the present invention to provide a new hitch mounted shopping cart carrier device and methods of use therein which may be used for loading, supporting and transporting of a conventional type shopping cart.

Another object of the present invention to provide a new hitch mounted shopping cart carrier device and methods of use therein which is of durable and reliable constructions.

And another object of the present invention is to provide a new hitch mounted shopping cart carrier device and methods of use therein which is susceptible of a low cost of manufacture with regard to both materials and labor, and which accordingly is then susceptible of low prices of sale to the consuming public, thereby making such a hitch mounted shopping cart carrier device economically available to the buying public.

Still another object of the present invention is to provide a hitch mounted shopping cart carrier device and methods therein which can be used for transporting a personal conventional type shopping cart loaded with groceries without unloading the groceries out of the shopping cart into an automotive vehicle.

Yet another object of the present invention is to provide a hitch mounted shopping cart carrier device that is used with an advertising method which can providing a relatively inexpensive and highly effective method of advertising wherein advertising indicia may be placed on the hitch mounted shopping cart carrier device which can be viewed by any individual passing the carrier device.

A further object of the present invention is to provide a hitch mounted shopping cart carrier device that is used in combination with a wheeled shopping cart owned and operated by a shopping and delivery service.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there is illustrated preferred embodiments of the invention.

### BRIEF DESCRIPTION OF THE DRAWINGS

FIG. 1 is a rear perspective view of the hitch mounted shopping cart carrier device of the present invention.

FIG. 2 is a side view of the hitch mounted shopping cart carrier device shown transporting a conventional shopping cart and mounted to a receiver hitch of a vehicle.

### DETAILED DESCRIPTION OF THE INVENTION

The description below of a preferred embodiment of the subject invention will be a description of only one potential embodiment considered to be within the scope of the subject invention. Consequently, a description of such a preferred embodiment of the subject invention will not be considered as limiting the scope of the invention as set forth in the claims annexed hereto. It is further to be stressed that in describing the preferred embodiment of the subject invention, the following described definitions, reference points, and reference axes will be utilized. Since the preferred embodiment of the subject invention includes a carrier device for connection to the rear of a vehicle, the word “frontal” will be used in reference to the front area of a vehicle, while the words “posterior” or “rear” will be used relative to direction disposed toward the rear of such a vehicle and generally extending towards a posterior direction from such vehicle.

The words “longitudinal central axis” will refer to that axis which extends through the center, as seen in crosssection, of an object from the one end to the other end thereof over its longest extend; or alternately stated, from one extreme point to the most distal point on such object. The word “longitudinal” or “longitudinally extending” shall mean a direction extending more generally lengthwise in a given direction than otherwise. The word “transverse” or transversely will mean the lateral or width distance over a given object, which will be considered generally perpendicular to the longitudinal central axis of such object. The work “upper” will refer to distances extending above and away from the ground and the word “lower” will refer to those areas extending toward the ground reference. In this latter respect, the ground reference will be considered level or horizontal. Whenever the words “left” or “right” are used in the following description, they will be used, unless otherwise stated, in reference to any orientation of the left and right hand when one faces the carrier from a position posterior to the vehicle to which the carrier is connected.

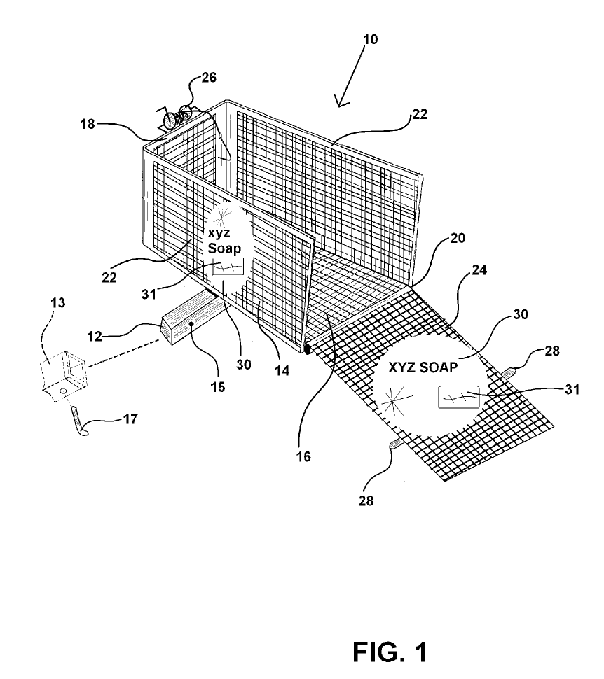

Referring now to the drawings, and specifically to FIG. 1, the hitch mounted shopping cart carrier device 10 of the present invention, shown in a functional opened position, is seen to include a hitch bar 12 having frontal and posterior ends, said frontal end of hitch bar 12 being adapted for mounting in a standard hitch receiver 13 on a vehicle and includes a pin aperture hole 15 said pin aperture hole 15 slidably receives a lynch pin 17. Said posterior end of hitch bar 12 is rigidly affixed to the underside of a platform assembly 14. Said platform assembly 14 being fabricated of metal wire, plastic resin, steel or aluminum mesh. Said platform assembly 14 includes an essentially horizontal floor 16 with left and right ends, a narrow front face 18 extending vertically upwardly from the right end of said horizontal floor 16, a wider opening 20 at left end of said horizontal floor 16 and tapering sides 22 there between. Said platform assembly 14 is configurated and dimensioned for the receipt of a wheeled conventional type shopping cart. A loading ramp 24 is rotatably attached to said left end of said horizontal floor 16. A winch assembly 26 is rigidly affixed to the upper end said narrow front face 18. Said loading ramp 24 includes a latch means 28 for securing said loading ramp 24 in a raised upright position. The platform assembly 14 and loading ramp 24 are adapted for receiving advertising indicia 30 thereon. The advertising indicia 30 may be in the form of placards or stickers with a design element including a logo, a pattern, a slogan, a word, a phrase, a flag, a scene, an animal, a fictional character, a person, a landscape, a graphic or the like. The advertising indicia 30 may include at least one detachable coupon 31 thereon. A logo may be any recognizable element representing a group or entity, such as, but not limited to, a sports team or a business concern. A pattern may include any pattern desired, such as a geometric pattern, a pattern to simulate a run of bricks, a pattern to simulate shingles or other siding materials or a random pattern. A fictional character may include, but is not limited to, theme characters, such as cartoon characters, fairy tale characters and the like removably attached to any viewable surfaces of said platform assembly 14 and loading ramp 24 in a conventional manner.

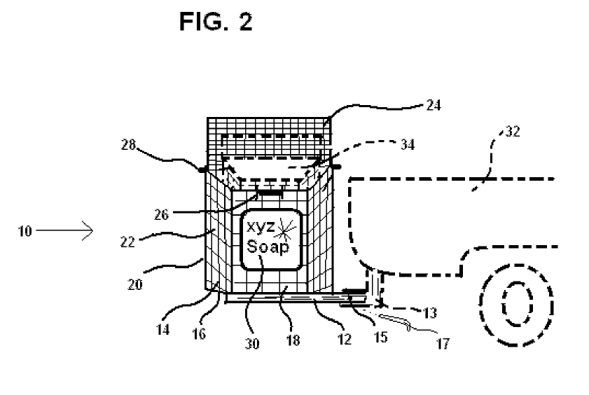

Referring now to the drawings, and specifically to FIG. 2, the hitch mounted shopping cart carrier device 10 of the present invention, is shown transporting a shopping cart 34 and mounted to a receiver hitch 13 of a vehicle 32. The carrier device is seen to include a hitch bar 12 having frontal and posterior ends, said frontal end of said hitch bar 12 being adapted for mounting in a standard hitch receiver 13 on a vehicle 32 and includes a pin aperture hole 15 said pin aperture hole 15 slidably receives a lynch pin 17. Said posterior end of said hitch bar 12 is rigidly affixed to the underside of a platform assembly 14. Said platform assembly 14 being fabricated of metal wire, plastic resin, steel or aluminum mesh. Said platform assembly 14 includes an essentially horizontal floor 16 with left and right ends, a narrow front face 18 extending vertically upwardly from said right end of said horizontal floor 16, a wider opening 20 at said left end of said horizontal floor 16 and tapering sides 22 there between. Said platform assembly 14 is configurated and dimensioned for the receipt of a wheeled conventional type shopping cart 34. A loading ramp 24 is rotatably attached to said left end of said horizontal floor 16. A winch assembly 26 is rigidly affixed to the upper portion of said narrow front face 18. Said loading ramp 24 includes a latch means 28 for securing said loading ramp 24 in a raised upright position. The platform assembly 14 and loading ramp 24 are adapted for receiving advertising indicia 30 thereon. The advertising indicia 30 may be in the form of placards or stickers with a design element including a logo, a pattern, a slogan, a word, a phrase, a flag, a scene, an animal, a fictional character, a person, a landscape, a graphic or the like. A logo may be any recognizable element representing a group or entity, such as, but not limited to, a sports team or a business concern. A pattern may include any pattern desired, such as a geometric pattern, a pattern to simulate a run of bricks, a pattern to simulate shingles or other siding materials or a random pattern. A fictional character may include, but is not limited to, theme characters, such as cartoon characters, fairy tale characters and the like removably attached to any viewable surfaces of said platform assembly 14 and loading ramp 24 in a conventional manner. In one embodiment where the hitch mounted shopping cart carrier device 10 comprises a design element, the design element may serve as a form of advertisement 30 for a business entity or other group desiring exposure. In such a use, the manufacturer of the hitch mounted shopping cart carrier device 10 identifies a third party interested in advertising on the hitch mounted shopping cart carrier device 10 and offers the viewable surfaces of said loading ramp 24, narrow front face 18, horizontal floor 16, and tapering sides 22 of said platform assembly 14 of said hitch mounted shopping cart carrier device 10 as advertising space for sell to the third party. The advertisement 30 may then be placed on the viewable surfaces of said loading ramp 24, narrow front face 18, horizontal floor 16, and tapering sides 22 of said platform assembly 14 of said hitch mounted shopping cart carrier device 10 such that the advertisements 30 are viewable by at least a portion of the public at large. The design element may be as described above. Such a system may be referred to as an advertising method using the described hitch mounted shopping cart carrier device 10. For example, the advertisers on the hitch mounted shopping cart carrier device 10, such as an consumer package goods manufacturer, may wish to display its corporate logo and/or advertising message 30 on the hitch mounted shopping cart carrier device 10. The advertising indicia 30 may include at least one detachable coupon 31 thereon. Such a logo and/or advertising message 30 would serve an advertising function to the advertisers on the hitch mounted shopping cart carrier device 10.

Those skilled in the art will appreciate that various adoptions and modifications of the invention as described above can be configured without departing from the scope and spirit of the invention. Therefore, it is to be understood that, within the scope of the appended claims, the invention may be practiced other than as specifically described herein.

What I claim is:

1. A hitch mounted shopping cart carrier device is adapted for receipt and transport of a conventional shopping cart, comprising:
a rigid horizontally disposed generally square tubular hitch bar comprising frontal and posterior ends, said frontal end being adapted for mounting in a standard hitch receiver on a vehicle, said posterior end of said hitch bar is rigidly affixed to the underside of a platform assembly; said platform assembly having an essentially horizontal floor with left and right ends, a narrow front face extending generally vertically upwardly from said right end of said horizontal floor, a wider opening at left end of said horizontal floor and tapering sides therebetween, a loading ramp is rotatably attached to said left end of said horizontal floor of said platform assembly.

2. The carrier device as claimed in claim 1, wherein said platform assembly is configurated and dimensioned to receive a wheeled conventional type shopping cart.

3. The carrier device as claimed in claim 1, wherein said platform assembly being fabricated of metal wire, plastic resin, steel or aluminum mesh.

4. The carrier device as claimed in claim 1, further comprising a latch means for securing said loading ramp in a raised upright position.

5. The carrier device as claimed in claim 1, further comprising a winch assembly rigidly affixed to the upper end of said narrow front face of said platform assembly.

6. The carrier device as claimed in claim 1, wherein at least one viewable surface of said narrow front face, said horizontal floor, said tapering side, and said loading ramp of said platform assembly is adapted for receiving indicia thereon, wherein the indicia comprises advertising.

7. The carrier device as claimed in claim 6, wherein said indicia is removably attached to at least one viewable surface of said narrow front face, said horizontal floor, said tapering sides, and said loading ramp of said platform assembly.

8. An advertising method comprising: placing a plurality of advertisements on said hitch mounted shopping cart carrier device such that said advertisements are viewable by at least a portion of the public.

9. The advertising method of claim 8 where said advertisements are placed on at least one viewable surface of said narrow front face, said horizontal floor, said tapering sides, and said loading ramp of said platform assembly of said hitch mounted shopping cart carrier device.

10. The advertising method of claim 8 further comprising contacting a third party interesting in placing an advertisement on at least one viewable surface of said narrow front face, said horizontal floor, said tapering sides, and said loading ramp of said platform assembly of said hitch mounted shopping cart carrier device.

11. The advertising method of claim 8 wherein said placing is provided for a fee.

12. The advertising method of claim 8 wherein said advertisements are constituted by images of products associated with a merchandising enterprise.

13. The advertising method of claim 8 wherein said advertisements further comprises at least one detachable coupon placed thereon.

14. The advertising method of claim 8 wherein said advertisements are being fabricated as a waterproof promotional sheet.

15. The advertising method of claim 8 wherein said advertisements comprises a design element.

16. The advertising method of claim 15 wherein said design element is a logo, a pattern, a slogan, a word, a phrase, a flag, a scene, an animal, a fictional character, a person, a landscape or a graphic.

17. The advertising method of claim 16 wherein said logo is a recognizable element representing a group or entity.

18. The advertising method of claim 17 wherein said group or entity is a business.

19. The advertising method of claim 8 wherein said hitch mounted shopping cart carrier device may be offered as a promotional item.

20. A method of use wherein said hitch mounted shopping cart carrier device is used in combination with a wheeled shopping cart owned and operated by a person, or a business.
